(19) United States
(12) Patent Application Publication
(10) Pub. No.: US 2022/0113774 A1
(43) Pub. Date: Apr. 14, 2022

(54) ADD-IN CARD WITH LOW PROFILE POWER CONNECTOR

(71) Applicant: Intel Corporation, Santa Clara, CA (US)

(72) Inventors: Shahin AMIRI, Richmond Hill (CA); Mirui WANG, Oshawa (CA); Evan PANG, Vaughan (CA); Robert SCHUM, Beaverton, OR (US); Shahed SAFAVI-BAYAT, Toronto (CA); Xuefeng MA, Scarborough (CA); Jason LEE PACK, North York (CA); Yvan LARGE, Richmond Hill (CA)

(21) Appl. No.: 17/556,703

(22) Filed: Dec. 20, 2021

(51) Int. Cl. G06F 1/20; G06F 13/42

(52) U.S. Cl. CPC G06F 1/20; G06F 2213/0026; G06F 13/4221

(57) ABSTRACT

An apparatus is described. The apparatus includes an add-in card having a power connector to receive power other than through the add-in card's host connector. The power connector fitted in a notch of a printed circuit board of the add-in card so that, when the printed circuit board is oriented to have an upper surface with semiconductor chips disposed thereon, an upper surface of the connector is above the upper surface of the printed circuit board and a lower surface of the connector is below a lower surface of the printed circuit board.

### BACKGROUND

System design engineers face challenges, especially with respect to high performance data center computing, as both computers and networks continue to pack higher levels of performance resulting in higher heat dissipation. Creative packaging solutions are therefore being designed to keep pace with the thermal requirements of such aggressively designed systems.

### FIGURES

FIG. 1 shows a prior art add-in card (prior art);

FIG. 2 shows an improved add-in card;

FIGS. 3a, 3b and 3c show an add-in card power connector;

FIG. 4 shows another add-in card power connector;

FIG. 5 shows a system;

FIG. 6 shows a data center;

FIG. 7 shows a rack.

### DETAILED DESCRIPTION

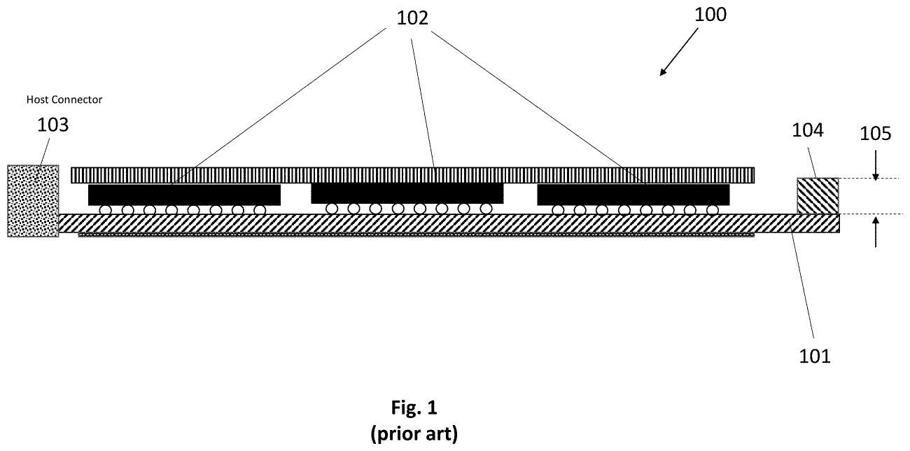

FIG. 1 shows a side view of a prior art add-in card 100. An add-in card 100 is a small form factor printed circuit (PC) board 101 (also referred to as an electronic circuit board) with integrated electronic circuitry (packaged semiconductor chips 102) that plug into a larger circuit board such as the motherboard of a computer system (the motherboard has a socket that a connector 103 of the add-in card plugs into).

The add-in card 100 of FIG. 1 can be viewed as a Peripheral Component Interface Express (PCIe) “single slot” form factor card having a height restriction 105 of 14.47 mm for components mounted on the circuit board 101 on the end of the card opposite the host connector 103.

With the continued increase of the performance of the semiconductor chips 103 that are integrated on the card and their corresponding increase in power consumption, the power consumption of many single slot cards is exceeding the power service provided by the host connector (=75 W).

In order to provide such cards with the additional power they need, a power connector 104 is placed at the edge of the card opposite the host connector 103. A technician plugs power supply wires into the power connector's receptacles and the additional supply voltage and current draw from these wires provides the card with the additional power it needs.

A first such power connector having six power plug receptacles can receive an additional 75 W of extra power whereas a second such power connector 104 having eight power plug receptacles can receive an additional 150 W of power.

A problem is that either of these power connectors will block airflow across the card's semiconductor chips 103. Here, the thermal design of a standard PCIe card does contemplate the need for extra power nor the existence of the aforementioned power connector 104. As such, the thermal design for a standard PCIe card assumes the edge of the card that is opposite the host connector 103 is open to receive a cool air inflow. In this case, cool air is drawn over the card edge and blows across the card's semiconductor chips 103 thereby removing heat generated by the chips 103.

When the power connector 104 is present, however, the cool air's inflow is blocked which, in turn, diminishes the cooling capacity of the card's thermal design. The diminished cooling capacity is particularly troublesome because the higher power consumption chips 103 that cause the higher power consumption of the card as a whole and necessitates the extra power connector 104 dissipate even more heat which is best addressed with increased air flow and not diminished airflow.

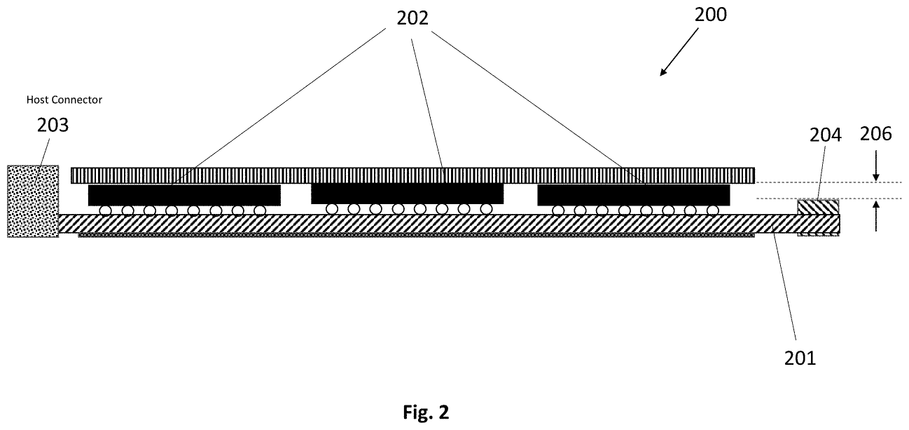

A solution, as observed in FIG. 2, is to effectively lower the power connector's position by dropping the bottom of the connector 204 through the printed circuit board 201. Here, referring to the prior art design of FIG. 1, note that the bottom of the connector 104 is mounted to the top of the printed circuit board 101.

By contrast, in the improved card 200 of FIG. 2, a new mounting approach is taken that effectively drops the bottom of the connector 204 beneath the printed circuit board 201. The lowering of the connector 204 creates a more open window 206 at the edge of the card that allows enough air inflow to sufficiently cool the card's semiconductor chips 203.

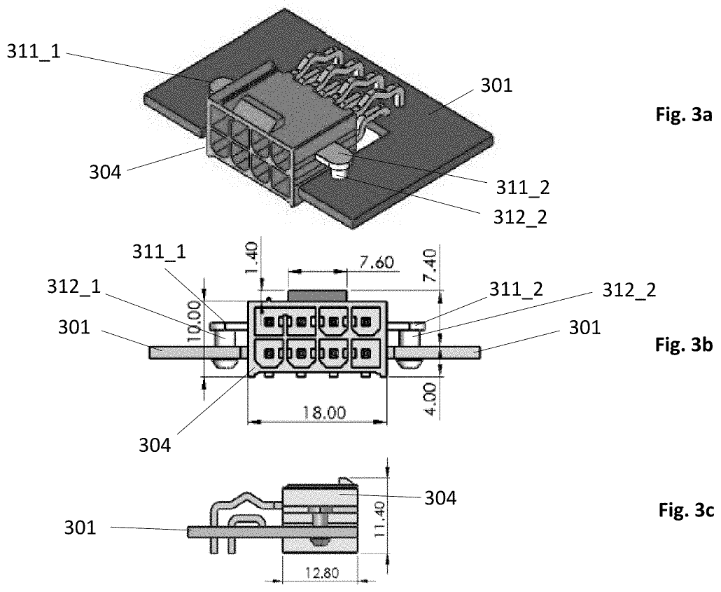

FIG. 3a,b,c show a more detailed view of the improved connector mount (FIG. 3a shows an angled view, FIG. 3b shows a front facing view, FIG. 3c shows a side view). As observed in FIG. 3a, the power connector 304 is manufactured to include mounting bars 311_1, 311_2 that emanate from opposite sides of the power connector 304 along the connector's width. Additionally, a notch is cut out of the edge of the printed circuit board 301 to allow the base of the connector 304 to drop through the plane of the printed circuit board 301. The mounting bars 311_1, 311_2 are secured to fixturing elements 312_1, 312_2 (e.g., threaded hollow posts/studs and corresponding bolt/screw) that are located on the printed circuit board 301 near opposite edges of the notch.

In the particular embodiment of FIGS. 3a,b,c, the mounting bars 311_1, 311_2 emanate from the connector above the top side of the printed circuit board 301.

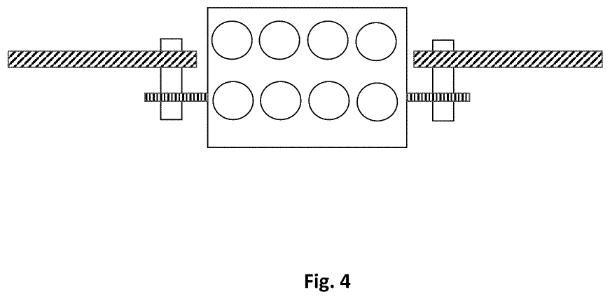

FIG. 4 shows another embodiment in which the mounting bars 411_1, 411_2 emanate from the connector 404 underneath the printed circuit board 401. The approach of FIG. 4 can be particularly useful if an even wider window opening for air inflow is desired because the approach of FIG. 4 can drop the bottom of the connector 404 even lower through the plane of the printed circuit board 401 than the approach of FIGS. 3a,b,c.

In one embodiment the power connector has six receptacles and can receive an additional 75 W of power. In another embodiment, the power connector has eight receptacles and can receive an additional 150 W of power. Other embodiments can entertain different numbers of receptacles and provide different amounts of additional power.

A PCIe form factor card having the power connector described above can be an accelerator card having one or more accelerator semiconductor chips and/or networking interface chips (e.g., general purpose processors that execute acceleration software, graphics processing unit (GPU) chips, artificial intelligence chips, network processor chips, network interface chips, cryptographic accelerator chips, crypto mining chips, etc.).

Although embodiments above have been directed to a PCIe form factor add-in card, the teachings above can be applied to other add-in card (including small form factor add-in cards) such as input/output (I/O) modules (e.g., network adaptor cards) and enterprise and data center SSD form factor (EDSFF) devices. Any of these add-in cards can be, as just some examples, graphics cards, smart network interface card (smart NIC), cryptographic accelerator card, crypto mining card, machine learning card, inference engine card, artificial intelligence card, image processing card, etc.

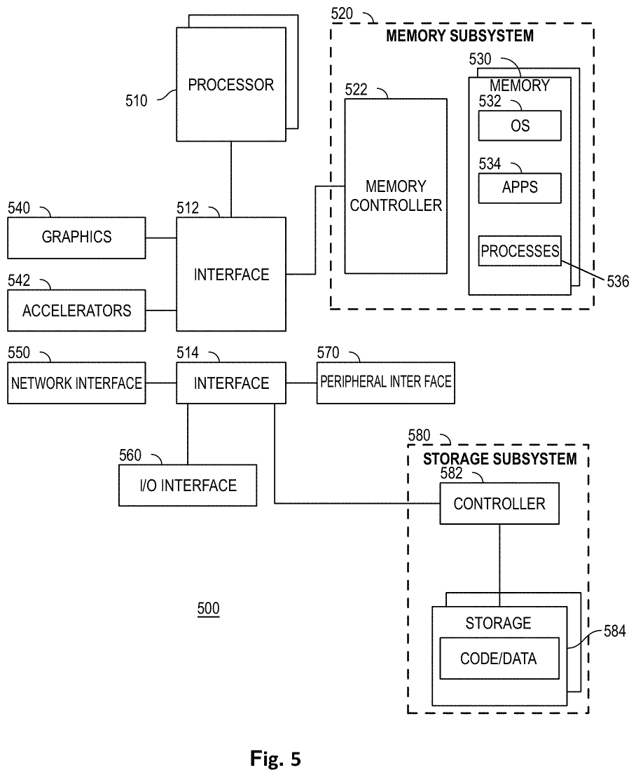

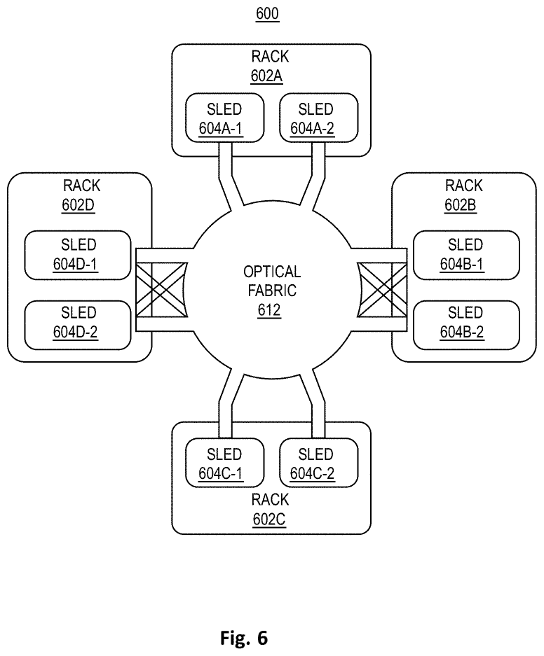

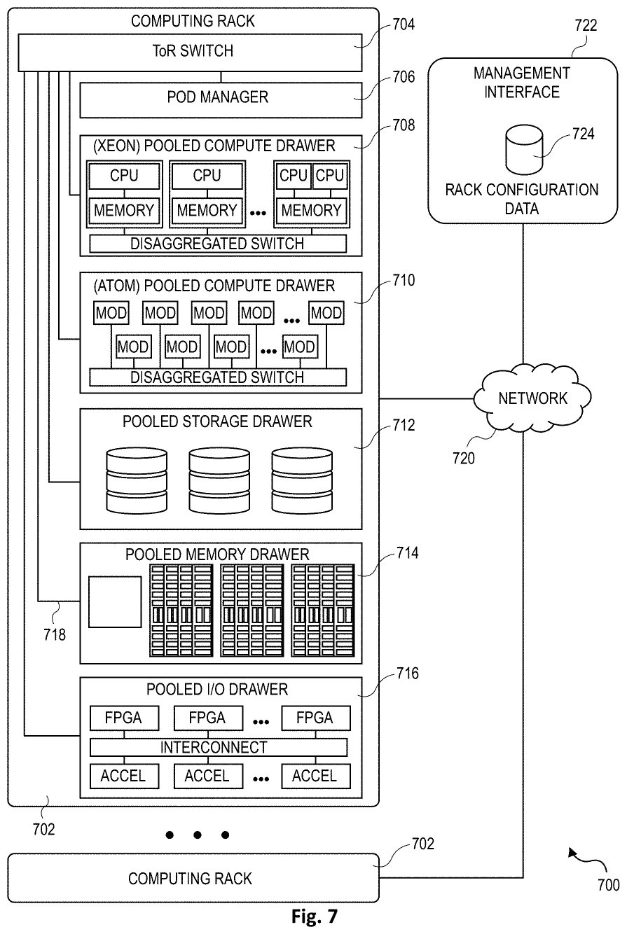

The following discussion concerning FIGS. 5, 6 and 7 are directed to systems, data centers and rack implementations, generally. FIG. 5 generally describes possible features of an electronic system that can include an add-in card having a low profile power connector for extra power as described above. FIG. 6 describes possible features of a data center that can include such electronic systems. FIG. 7 describes possible features of a rack having one or more such electronic systems installed into it.

FIG. 5 depicts an example system. System 500 includes processor 510, which provides processing, operation management, and execution of instructions for system 500. Processor 510 can include any type of microprocessor, central processing unit (CPU), graphics processing unit (GPU), processing core, or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

Certain systems also perform networking functions (e.g., packet header processing functions such as, to name a few, next nodal hop lookup, priority/flow lookup with corresponding queue entry, etc.), as a side function, or, as a point of emphasis (e.g., a networking switch or router). Such systems can include one or more network processors (NPUs) to perform such networking functions (e.g., in a pipelined fashion or otherwise).

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die. Where present, graphics interface 540 interfaces to graphics components for providing a visual display to a user of system 500. In one example, graphics interface 540 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 540 generates a display based on data stored in memory 530 or based on operations executed by processor 510 or both. In one example, graphics interface 540 generates a display based on data stored in memory 530 or based on operations executed by processor 510 or both.

Accelerators 542 can be implemented, e.g., as a plug-in or add-in card having multiple high performance accelerator chip packages and a low profile power connector for additional power as described above. Accelerators 542 can be a fixed function offload engine that can be accessed or used by a processor 510. For example, an accelerator among accelerators 542 can provide compression (DC) capability, cryptography services such as public key encryption (PKE), cipher, hash/authentication capabilities, decryption, or other capabilities or services. In some embodiments, in addition or alternatively, an accelerator among accelerators 542 provides field select controller capabilities as described herein. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), “X” processing units (XPUs), programmable control logic circuitry, and programmable processing elements such as field programmable gate arrays (FPGAs). Accelerators 542 can provide multiple neural networks, processor cores, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, volatile memory, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software functionality to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510. In some examples, a system on chip (SOC or SoC) combines into one SoC package one or more of: processors, graphics, memory, memory controller, and Input/Output (I/O) control logic circuitry.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). A memory subsystem as described herein may be compatible with a number of memory technologies, such as DDR3 (Double Data Rate version 3, original release by JEDEC (Joint Electronic Device Engineering Council) on Jun. 27, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/Output version 2, JESD229-2 originally published by JEDEC in August 2014, HBM (High Bandwidth Memory), JESD235, originally published by JEDEC in October 2013, LPDDR5, HBM2 (HBM version 2), or others or combinations of memory technologies, and technologies based on derivatives or extensions of such specifications.

In various implementations, memory resources can be “pooled”. For example, the memory resources of memory modules installed on multiple cards, blades, systems, etc. (e.g., that are inserted into one or more racks) are made available as additional main memory capacity to CPUs and/or servers that need and/or request it. In such implementations, the primary purpose of the cards/blades/systems is to provide such additional main memory capacity. The cards/blades/systems are reachable to the CPUs/servers that use the memory resources through some kind of network infrastructure such as CXL, CAPI, etc.

The memory resources can also be tiered (different access times are attributed to different regions of memory), disaggregated (memory is a separate (e.g., rack pluggable) unit that is accessible to separate (e.g., rack pluggable) CPU units), and/or remote (e.g., memory is accessible over a network).

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a HyperTransport or industry standard architecture (ISA) bus, a small computer system interface (SCSI) bus, Remote Direct Memory Access (RDMA), Internet Small Computer Systems Interface (iSCSI), NVM express (NVMe), Coherent Accelerator Interface (CXL), Coherent Accelerator Processor Interface (CAPI), Cache Coherent Interconnect for Accelerators (CCIX), Open Coherent Accelerator Processor (Open CAPI) or other specification developed by the Gen-z consortium, a universal serial bus (USB), or an Institute of Electrical and Electronics Engineers (IEEE) standard 1394 bus.

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. Network interface 550 can include an Ethernet adapter, wireless interconnection components, cellular network interconnection components, USB (universal serial bus), or other wired or wireless standards-based or proprietary interfaces. Network interface 550 can transmit data to a remote device, which can include sending data stored in memory. Network interface 550 can receive data from a remote device, which can include storing received data into memory. Various embodiments can be used in connection with network interface 550, processor 510, and memory subsystem 520.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits in both processor 510 and interface 514.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

A power source (not depicted) provides power to the components of system 500. More specifically, power source typically interfaces to one or multiple power supplies in system 500 to provide power to the components of system 500. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 500 can be implemented as a disaggregated computing system. For example, the system 500 can be implemented with interconnected compute sleds of processors, memories, storages, network interfaces, and other components. High speed interconnects can be used such as PCIe, Ethernet, or optical interconnects (or a combination thereof). For example, the sleds can be designed according to any specifications promulgated by the Open Compute Project (OCP) or other disaggregated computing effort, which strives to modularize main architectural computer components into rack-pluggable components (e.g., a rack pluggable processing component, a rack pluggable memory component, a rack pluggable storage component, a rack pluggable accelerator component, etc.).

Although a computer is largely described by the above discussion of FIG. 5, other types of systems to which the above described invention can be applied and are also partially or wholly described by FIG. 5 are communication systems such as routers, switches and base stations.

FIG. 6 depicts an example of a data center. Various embodiments can be used in or with the data center of FIG. 6. As shown in FIG. 6, data center 600 may include an optical fabric 612. Optical fabric 612 may generally include a combination of optical signaling media (such as optical cabling) and optical switching infrastructure via which any particular sled in data center 600 can send signals to (and receive signals from) the other sleds in data center 600. However, optical, wireless, and/or electrical signals can be transmitted using fabric 612. The signaling connectivity that optical fabric 612 provides to any given sled may include connectivity both to other sleds in a same rack and sleds in other racks.

Data center 600 includes four racks 602A to 602D and racks 602A to 602D house respective pairs of sleds 604A-1 and 604A-2, 604B-1 and 604B-2, 604C-1 and 604C-2, and 604D-1 and 604D-2. Thus, in this example, data center 600 includes a total of eight sleds. Optical fabric 612 can provide sled signaling connectivity with one or more of the seven other sleds. For example, via optical fabric 612, sled 604A-1 in rack 602A may possess signaling connectivity with sled 604A-2 in rack 602A, as well as the six other sleds 604B-1, 604B-2, 604C-1, 604C-2, 604D-1, and 604D-2 that are distributed among the other racks 602B, 602C, and 602D of data center 600. The embodiments are not limited to this example. For example, fabric 612 can provide optical and/or electrical signaling.

FIG. 7 depicts an environment 700 that includes multiple computing racks 702, each including a Top of Rack (ToR) switch 704, a pod manager 706, and a plurality of pooled system drawers. Generally, the pooled system drawers may include pooled compute drawers and pooled storage drawers to, e.g., effect a disaggregated computing system. Optionally, the pooled system drawers may also include pooled memory drawers and pooled Input/Output (I/O) drawers. In the illustrated embodiment the pooled system drawers include an INTEL® XEON® pooled computer drawer 708, and INTEL® ATOM™ pooled compute drawer 710, a pooled storage drawer 712, a pooled memory drawer 714, and a pooled I/O drawer 716. Each of the pooled system drawers is connected to ToR switch 704 via a high-speed link 718, such as a 40 Gigabit/second (Gb/s) or 100 Gb/s Ethernet link or an 100+Gb/s Silicon Photonics (SiPh) optical link. In one embodiment high-speed link 718 comprises an 600 Gb/s SiPh optical link.

Again, the drawers can be designed according to any specifications promulgated by the Open Compute Project (OCP) or other disaggregated computing effort, which strives to modularize main architectural computer components into rack-pluggable components (e.g., a rack pluggable processing component, a rack pluggable memory component, a rack pluggable storage component, a rack pluggable accelerator component, etc.).

Multiple of the computing racks 700 may be interconnected via their ToR switches 704 (e.g., to a pod-level switch or data center switch), as illustrated by connections to a network 720. In some embodiments, groups of computing racks 702 are managed as separate pods via pod manager(s) 706. In one embodiment, a single pod manager is used to manage all of the racks in the pod. Alternatively, distributed pod managers may be used for pod management operations. RSD environment 700 further includes a management interface 722 that is used to manage various aspects of the RSD environment. This includes managing rack configuration, with corresponding parameters stored as rack configuration data 724.

Any of the systems, data centers or racks discussed above, apart from being integrated in a typical data center, can also be implemented in other environments such as within a bay station, or other micro-data center, e.g., at the edge of a network.

In various embodiments multiple computer systems that are plugged into racks implement functionality of a data center through execution of software that invokes acceleration, where, the acceleration is performed at least in part with an accelerator add-in card that is plugged into one of the multiple computer systems. The add-in card has any/all of the improvements described at length above.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may be implemented using or as an article of manufacture or at least one computer-readable medium. A computer-readable medium may include a non-transitory storage medium to store program code. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the program code implements various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

To the extent any of the teachings above can be embodied in a semiconductor chip, a description of a circuit design of the semiconductor chip for eventual targeting toward a semiconductor manufacturing process can take the form of various formats such as a (e.g., VHDL or Verilog) register transfer level (RTL) circuit description, a gate level circuit description, a transistor level circuit description or mask description or various combinations thereof. Such circuit descriptions, sometimes referred to as “IP Cores”, are commonly embodied on one or more computer readable storage media (such as one or more CD-ROMs or other type of storage technology) and provided to and/or otherwise processed by and/or for a circuit design synthesis tool and/or mask generation tool. Such circuit descriptions may also be embedded with program code to be processed by a computer that implements the circuit design synthesis tool and/or mask generation tool.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences may also be performed according to alternative embodiments. Furthermore, additional sequences may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

1. An apparatus, comprising:
an add-in card comprising a power connector to receive power other than through the add-in card's host connector, the power connector fitted in a notch of a printed circuit board of the add-in card so that, when the printed circuit board is oriented to have an upper surface with semiconductor chips disposed thereon, an upper surface of the connector is above the upper surface of the printed circuit board and a lower surface of the connector is below a lower surface of the printed circuit board.

2. The apparatus of claim 1 wherein the add-in card is a PCIe card.

3. The apparatus of claim 2 wherein the add-in card is an accelerator card.

4. The apparatus of claim 1 wherein the power connector is to receive 75 W of additional power for the add-in card.

5. The apparatus of claim 1 wherein the power connector is to receive 150 W of additional power for the add-in card.

6. A computer system, comprising:
one or more processors;
memory;
mass storage;
an add-in card comprising a power connector to receive power other than through the add-in card's host connector, the power connector fitted in a notch of a printed circuit board of the add-in card so that, when the printed circuit board is oriented to have an upper surface with semiconductor chips disposed thereon, an upper surface of the connector is above the upper surface of the printed circuit board and a lower surface of the connector is below a lower surface of the printed circuit board.

7. The computer system of claim 6 wherein the add-in card is a PCIe card.

8. The computer system of claim 7 wherein the add-in card is an accelerator card.

9. The computer system of claim 6 wherein the power connector is to receive 75 W of additional power for the add-in card.

10. The computer system of claim 6 wherein the power connector is to receive 150 W of additional power for the add-in card.

11. A data center, comprising:
multiple computer systems plugged into multiple racks, the multiple computer systems communicatively coupled to one another by way of one or more networks, the multiple computer systems to implement functionality of the data center through execution of software that invokes acceleration, the acceleration performed at least in part with an accelerator add-in card that is plugged into one of the multiple computer systems, the add-in card comprising a power connector to receive power other than through the add-in card's host connector, the power connector fitted in a notch of a printed circuit board of the add-in card so that a first surface of the connector extends beyond a first surface of the printed circuit board having semiconductor chips disposed thereon and a second surface of the connector extends beyond an opposite surface of the printed circuit board.

12. The data center of claim 11 wherein the add-in card is a PCIe card.

13. The data center of claim 12 wherein the add-in card is an accelerator card.

14. The data center of claim 11 wherein the power connector is to receive 75 W of additional power for the add-in card.

15. The data center of claim 11 wherein the power connector is to receive 150 W of additional power for the add-in card.
